(19) United States
(12) Patent Application Publication
(10) Pub. No.: US 2014/0222671 A1
(43) Pub. Date: Aug. 7, 2014

(54) System and method for the execution of third party services transaction over financial networks through a virtual integrated automated teller machine on an electronic terminal device.

(71) Applicant: Aurelio Elias, Hurst, TX (US)

(72) Inventor: Aurelio Elias, Hurst, TX (US)

(21) Appl. No.: 13/762,335

(22) Filed: Feb. 7, 2013

(51) Int. Cl. G06Q 20/02; G06Q 20/10

(52) U.S. Cl. CPC G06Q 20/02; G06Q 20/108
USPC 705/42; 705/44

(57) ABSTRACT

Disclosed is an automated computerized system and customer facing electronic device screen interface that acts as virtual integrated automated teller machine, referred to herein as the iATM system. The iATM system enables electronic terminal device users to request and authorize their preferred financial services through the existing automated teller machine (ATM) and point-of-sale (POS) networks by automating non bank third party financial services transactions on the electronic terminal device. The iATM system utilizes an aggregate of personal and third party services information, multifactor authentication and non-depository virtual accounts, acting as temporary transaction accounts, to enable transaction acquiring processors and third party service providers to give electronic device users access to third party services over financial networks, utilizing a new and novel method that requires no modifications to the existing ATM and POS network infrastructure.

This application claims the benefit of Provisional Patent Application Ser. No. 61/596,666, filed by present inventor, which is incorporated by reference.

### BACKGROUND

### Prior Art

The following is a tabulation of some prior art that presently appears relevant:

### United States Patents

| Pat. No. | Issue Date | Patentee |
|---|---|---|
| 5,650,604 | July 1997 | Marcous, et al. |
| 6,000,608 | December 1999 | Dorf |
| 6,796,492 | September 2004 | Gatto |
| 7,155,411 | December 2006 | Blinn, et al. |
| 7,182,252 | February 2007 | Cooper, et al. |
| 7,195,151 | March 2007 | Licciardello, et al. |
| 7,363,265 | April 2008 | Horgan |
| 7,415,442 | August 2008 | Battaglini, et al. |
| 7,416,115 | August 2008 | Licciadello, et al. |
| 7,512,254 | March 2009 | Vollkommer, et al. |
| 7,580,898 | August 2009 | Brown, et al. |
| 7,627,524 | December 2009 | Bennett, et al. |
| 7,644,037 | January 2010 | Battaglini, et al. |
| 7,664,703 | February 2010 | Hansen, et al. |
| 7,665,657 | February 2010 | Huh |
| 7,693,790 | April 2010 | Lawlor, et al. |
| 7,708,199 | May 2010 | Gatto |
| 7,720,754 | May 2010 | Gutierrez-Sheris |
| 7,780,075 | August 2010 | Cooper, et al. |
| 7,792,748 | September 2010 | Ebersole, et al. |
| 7,801,799 | September 2010 | Brake, Jr., et al. |
| 7,802,718 | September 2010 | Barcelou |
| 7,946,480 | May 2011 | Miller, et al. |
| 7,913,902 | March 2011 | Isaacson |
| 8,032,457 | October 2011 | Ostrovsky |
| 8,038,058 | October 2011 | Licciardello, et al. |
| 8,131,643 | March 2012 | Battaglini, et al. |
| 8,141,776 | March 2012 | Isaacson |
| 8,266,058 | September 2012 | Anderson |
| 8,301,500 | October 2012 | Pharris |

### Background

In today's economic environment, it often occurs that an individual will go to an automated teller machine (ATM) or a point of sale (POS) terminal and only have access to a limited set of services currently provided (e.g. store purchase, cash withdrawal, balance inquiry) but in fact may have the need to carry out other types of transactions (e.g. money transfer, bill pay, loan or prepaid access) An individual that is receiving funds or making a payment at an ATM or POS terminal must have a card account linked to a personal depository account or to a third party prepaid account to access the cash or affect a payment. Furthermore individuals using ATM and POS terminals are limited to transaction with card accounts issued by financial institutions with the exception of card gift cards that may be issued by merchants, but are limited to purchases from the issuing merchant. Currently there is no system or method to enable an individual to access an additional third party service on an electronic payment terminal unless the terminals are controlled by the financial services provider (e.g. Financial Institution, Money Services Business) that is offering the service, or when the payment terminal operator provides direct access to the third party services offered on the device, thus limiting the user to only the third party services offered by the terminal operator. Furthermore the proliferation of mobile phones and personal computing devices with cameras and both digital and voice capability has created an environment where mobility and access to online services is converging with existing terminal based payments systems. Examples of this convergence include online and mobile payments, wireless near-field-communications (NFC) swipe-less card and token readers, and other card-less automated teller machine (ATM) and point of sale (POS) technologies.

Although numerous examples currently exist of self service financial transaction kiosks, and multi-function ATM and POS systems that offer automated check cashing, money transfers, remote deposits, prepaid value loading and a plurality of other services, no known terminal or system currently exists that offer financial instrument holders access to the third party services of their choice, unless the services are offered through terminals that are controlled by the financial services provider, or when the payment terminal operator provides direct access to the third party services offered on the device. This limitation acts as a barrier to interoperability between the payment terminal operators and a multiplicity of third party service providers, because they must all be connected to the payment terminal in order to give their customers access to a plurality of third party services. Furthermore varying financial network operating rules and regulatory compliance requirements make financial services interoperability at the electronic payments terminal level difficult and costly to implement. The invention solves this problem through a unique method and system that enables third party services transactions and funds settlement to be handled through the electronic payments terminal (including but not limited implementations on personal computer, mobile devices or other terminals capable of access through the financial network and has this invention's interface) to affect a financial transaction via a automated computerized system and customer facing electronic device screen interface that acts as virtual integrated automated teller machine, referred to herein as the iATM system.

### SUMMARY

The invention relates generally to the field of apparatus and processes for automated financial transactions that occur via the use of an individual's financial instrument (e.g. credit or debit card, check, line of credit, token or cash), an electronic terminal device (e.g. computer, mobile phone, automated teller machine (ATM) or point-of-sale (POS) terminal), an electronic funds transfer transaction acquiring processor and a provider of third party financial services through a unique implementation of multifactor authorization techniques and transaction authorization methods to affect an electronic funds transfer utilizing an automated computerized system and customer facing electronic device screen interface.

Moreover it pertains specifically to such apparatus for the management and execution of said operation over existing financial networks utilizing among other elements, an aggregate of personal and third party services information, biometric authentication and a non-depository virtual account, acting as a temporary transaction account, to facilitate the transaction over existing financial network systems resulting in the authorization and settlement of electronic funds transfers.

The invention has many novel features not offered by the prior art apparatus that result in a new and much needed method for an alternative for accessing third party services by using the iATM computerized system user interface and non-depository virtual account management system, a third party services provider and an acquiring processor, which is simpler in construction, and which is not apparent, obvious, or suggested, either directly or indirectly by any of the prior art apparatus and more universally usable (utilizing existing financial network systems and multifactor authentication techniques) and more versatile in operation (combining customer facing electronic devices, third party processors and third party services) than known apparatus of this kind.

The foregoing has outlined, in general, the physical aspects of the invention and is to serve as an aid for better understanding the more complete detailed description which is to follow. In reference to such, there is to be a clear understanding that the present invention is not limited to the method or detail of construction, fabrication, material, or application of use described and illustrated herein. Any other variation of fabrication, use, or application should be considered apparent as an alternative embodiment of the invention.

### ADVANTAGES

The present embodiment of the system demonstrates a new and improved method for the issuance of a third party service over a financial network utilizing a non-depository virtual account management system for the purpose of enabling an individual to completed the requested third party transaction, comprising:
a. Provides a financial transaction process enabling the execution of a third party service over a financial network by acquiring processors and third party services providers.
b. Utilizes electronic transaction terminals, acquirer processing systems and third party services processing systems in a novel way to enable a holder of a financial instrument to access a third party services.
c. Utilizes a combination of personal service information, non-depository virtual accounts for transaction auditing and depository settlement accounts for transaction settlement enabling third party services providers to offer Pay-In and Pay-Out transactions on the existing financial network systems.
d. Utilizes a combination of personal service information and biometric identity tokens for verification of the individual on the existing financial network systems via an electronic terminal.
e. Utilizes a combination of personal service information and biometric identity tokens for verification of the individual on the existing financial network systems that employs multifactor authentication techniques.
f. Utilizes a combination of person service information, non-depository virtual accounts and biometric identity tokens to enable a transaction payment service to be issued (eCheck) as an electronic check image for transmission over common communication networks.

### DESCRIPTION OF THE FIRST EMBODIMENT

In view of the limitations now present in the prior art, the invention provides a new and useful system and method for offering an individual the ability to access a third party service over existing financial networks using the iATM system on an electronic terminal device, and to securely authenticate the user and validate the transaction with or without a card by employing multifactor authentication techniques and transaction authorization methods, and combining aggregated personal financial and third party service information to affect an electronic funds transfer on an electronic payment terminal, when the individual has selected a particular financial transaction, the non-depository virtual account management system has identified the user and has associated the financial instrument holder with a third party services provider, communicates the transaction details from the service provider to the financial instrument holder, thus providing an optional (e.g. Opt-In or Opt-Out) event on an electronic terminal device for authorizing the payment by using the acquiring processor as the qualifier and executor of the transaction.

The invention provides a new method for authorizing a third party service transaction, and authenticating and validating the user in a manner that insures rules compliance through the existing financial network systems (e.g. acquiring processor, electronic terminal interface and financial network protocols) and gives the user the ability (if needed) to opt-in or opt-out of the transaction on the basis of the third party services terms and conditions disclosure information utilizing a non-depository virtual account management system. The current state of the art does not offer this option for individuals to access third party services at the electronic payment terminal level that meets stringent know-you-customer (KYC) and record keeping financial services regulatory requirements unless the individual's financial instrument issuer (e.g. credit/debit card issuer) is the only source of transaction authorization available or unless the electronic terminal is programmed to directly access a third party service. Furthermore opportunities for fraud and varying regulatory and network compliance requirements make universal payment systems difficult to implement in multi-vendor environments. The user authentication present in the innovation is based on a system and method employing proven multifactor authentication that exceeds current regulatory KYC compliance requirements and virtually eliminates fraud.

When the individual who may or may not be a financial instrument holder initiates the transaction on the iATM customer facing electronic device screen interface, the iATM computerized system validates and authenticates the utilizing multifactor authentication techniques in a manner that meets the financial services rules compliance (e.g. customer identification program (CIP), Banking Secrecy Act (BAS) anti-money laundering (AML) and record keeping) requirements and mitigates fraud, the non-depository virtual account management system indentifies the third party services provider and accesses the personal service information, either existing in the non-depository virtual account management system or obtained from the third party services management system from which the iATM system receives an authorization from the third party services provider with transaction details (including but not limited to the amount, terms and conditions, and fees associated with completing the transaction) which are communicated in whole or in part to the individual through the iATM user interface (on any terminal device, e.g. ATM, POS, Smart Phone, KIOSK, etc.), thus enabling the individual to opt-in or opt-out of the transaction, if needed. The individual can be pre-qualified by the non-depository virtual account management system with the personal service information having pre-loaded values such as, terms and conditions, funding limits and pre-authorization conditions all managed by the iATM system and method. These values can be preset by the third party service provider or by the user through the iATM user interface. If financial instrument holder chooses to opt-in, the iATM automated computerized system generates a one-time-use PIN and sends it via a secure electronic digital message (e.g. electronic device screen, USSD or SMS text, email, electronic payment terminal receipt). The transaction is completed by the financial instrument holder entering an issuer identification number (IIN) and personal account number (PAN) and either a money transfer control number (MTCN) or a third party control number (TPCN) and a one-time-use PIN into the electronic device with or without needing a card, and the electronic payment terminal receives an authorization from the iATM computerized system through the transaction acquiring processor.

Moreover it pertains specifically to such apparatus for the execution of the option for individuals to access their aggregated personal service information from the third party service provider, authorizing the transaction and effect a settlement during a single transaction acquiring session with the acquiring processor on an electronic payment terminal. The iATM system authenticates the user utilizing multifactor authentication techniques (if required for compliance and fraud control purposes) and generates a virtual token (e.g. PIN, MTCN, TCPN) that is communicated to the user in the form a secure electronic digital message. The acquiring processor qualifies and executes the electronic funds transfer transaction based on the payment information provided by the financial instrument holder through the iATM system electronic device user interface.

When a Financial Instrument Holder: 1) Initiates a financial transaction on an electronic device, 2) the iATM system identifies and authenticates the Financial Instrument Holder, 3) the Compliance and Fraud Management System collects the required biometric and record keeping data, 4) the Non-Depository Virtual Account Management System identifies and authorize access to the Third Party Services Management System, 5) the Third Party Services Provider denies or authorizes the requested transaction, 6) if authorized, the Third Party Services Management System communicates to the Financial Instrument Holder through the screen interface, the terms and conditions of the transaction and any fees associated with completing the transaction, 7) if required, the Financial Instrument Holder is given the option to accept or refuse the transaction; 8) if the Financial Instrument Holder accepts the transaction, the iATM System authorizes the transaction and 9) the Non-Depository Virtual Account Management System initiates through the Acquiring Processor the settlement process for the transaction via the use of various Virtual Service Accounts (Non-Depository), Operating Accounts (Depository) and Settlement Accounts which settles the amount of the authorized transaction. Depending upon the state of art and implementation of this process, this transaction can happen in seconds.

### DRAWINGS

### Figures

The following drawings further describe by illustration the advantages of the invention. Each drawing is referenced by corresponding figure reference characters within the “DETAILED DESCRIPTION OF THE INVENTION” section to follow.

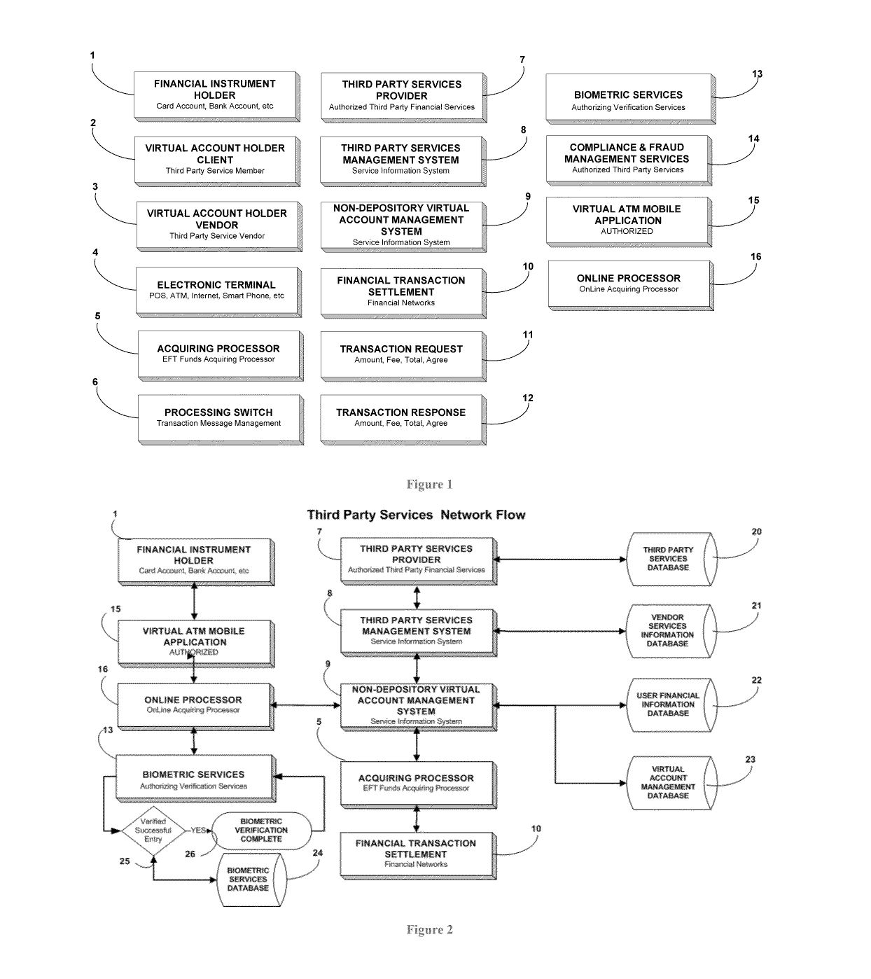

FIG. 1. is a view of the Operational Domains utilized according to the present invention.

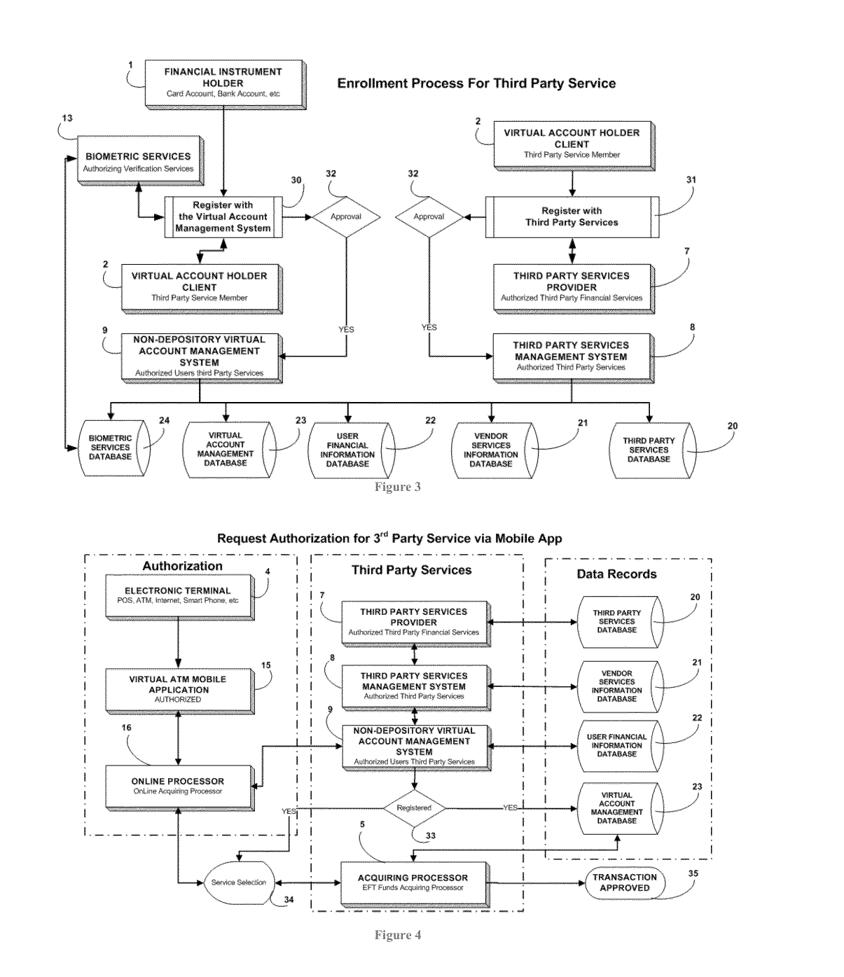

FIG. 2. Overview of the Third Party Services Network Flow

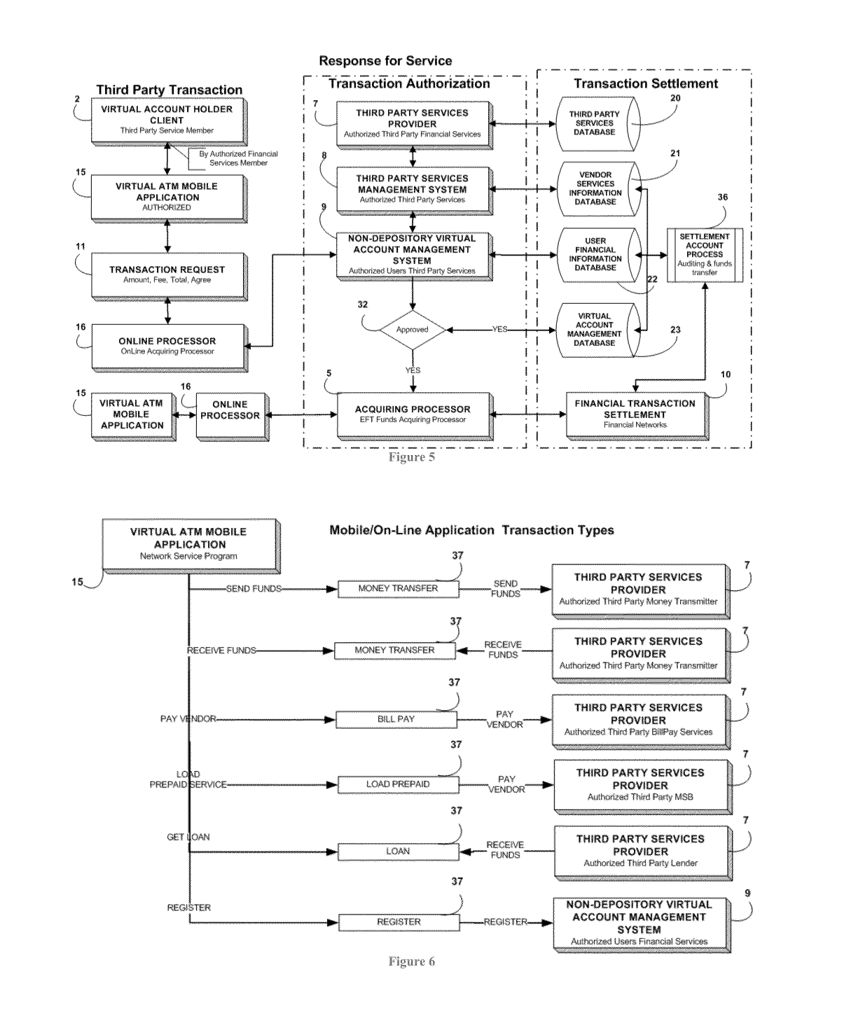

FIG. 3. Enrolling a Client for Third Party Services with Biometric Identification Data

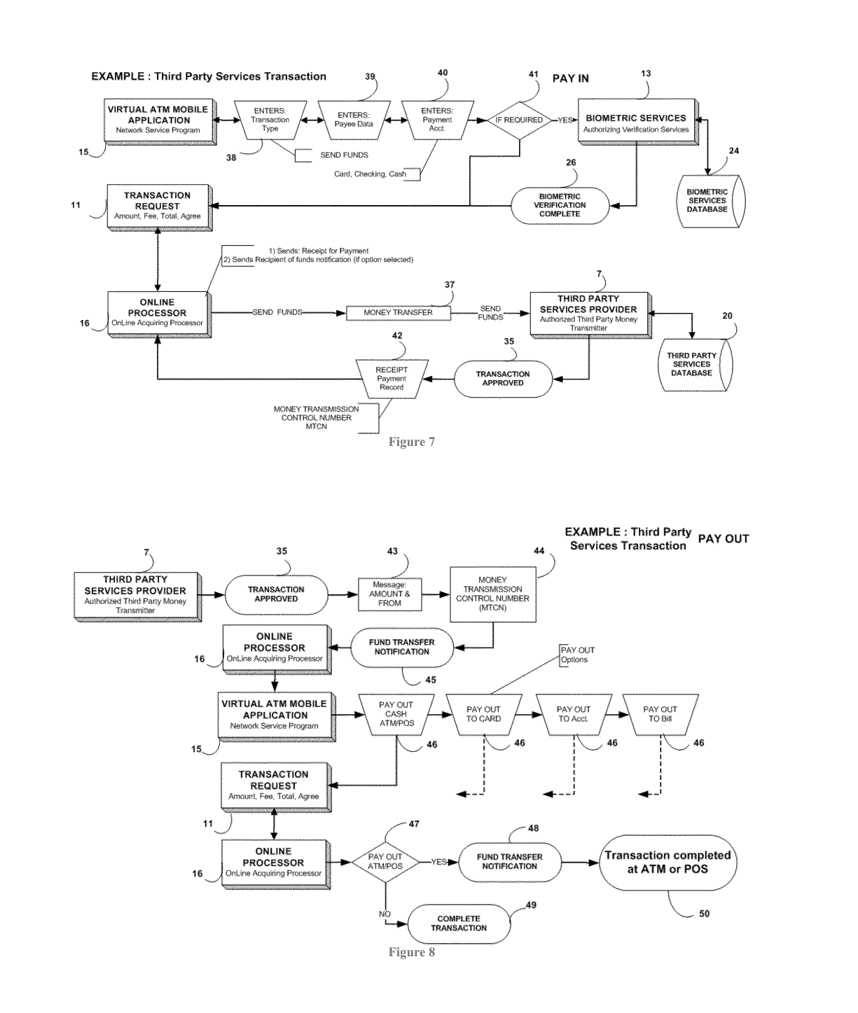

FIG. 4. Transaction Process—Request Authorization for Service

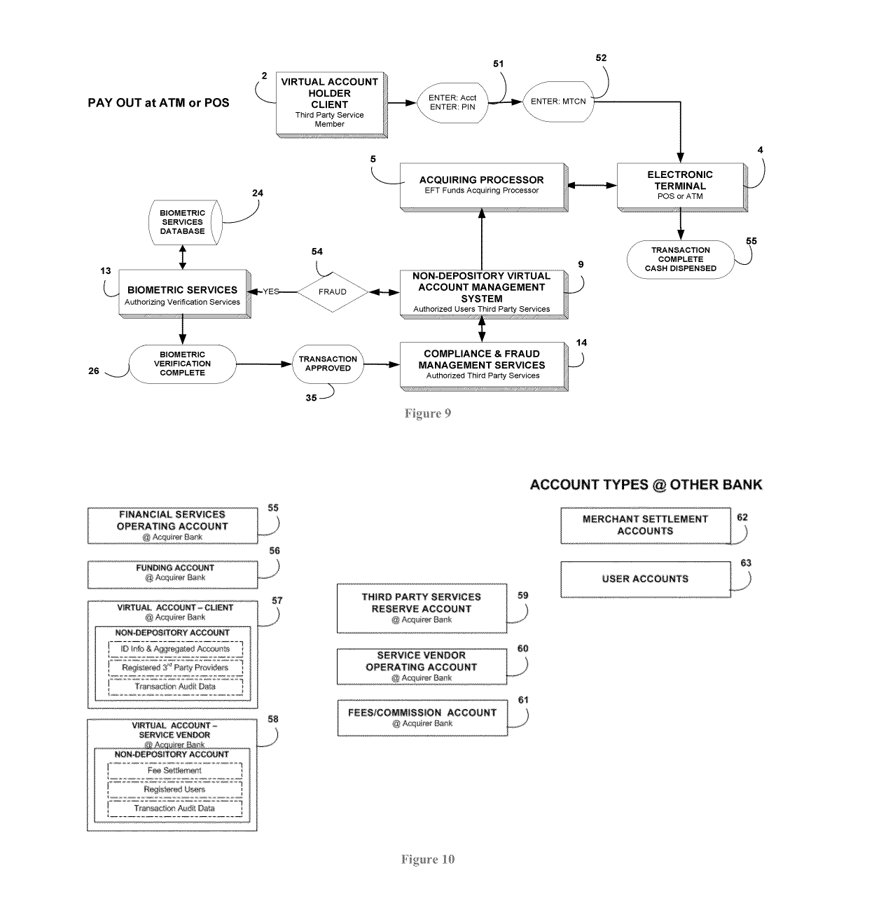

FIG. 5. Transaction Process—Response for Service

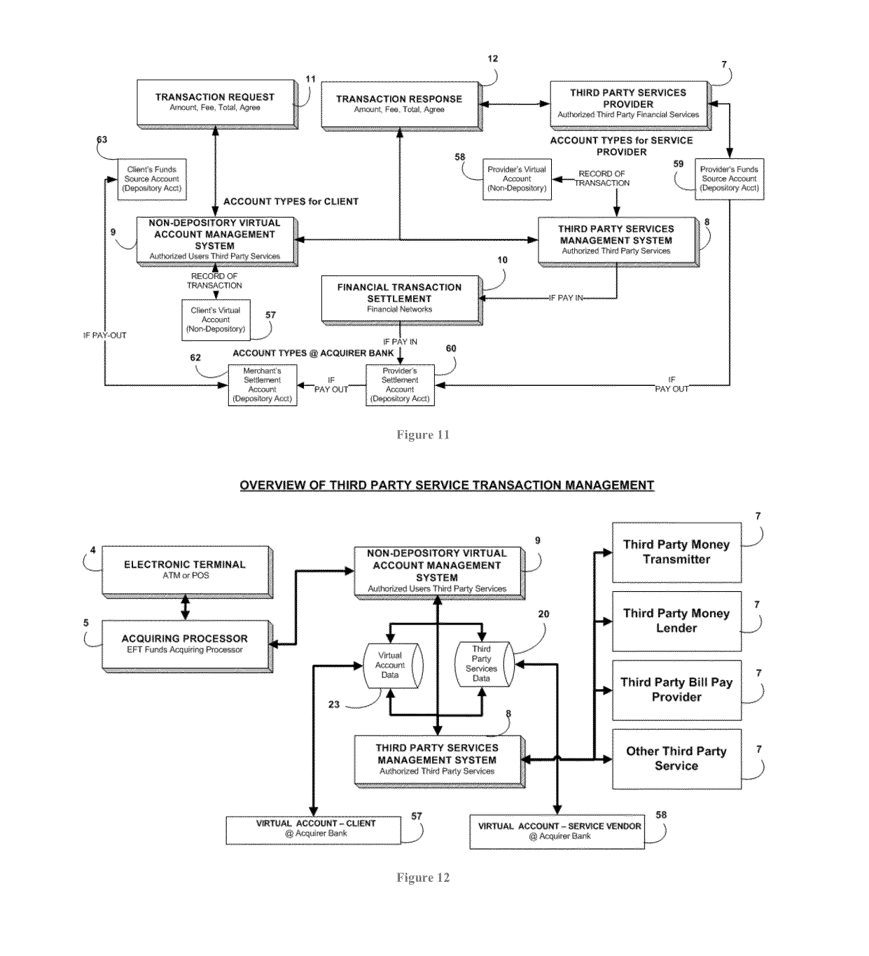

FIG. 6. Third Party Service Transaction Types example for iATM

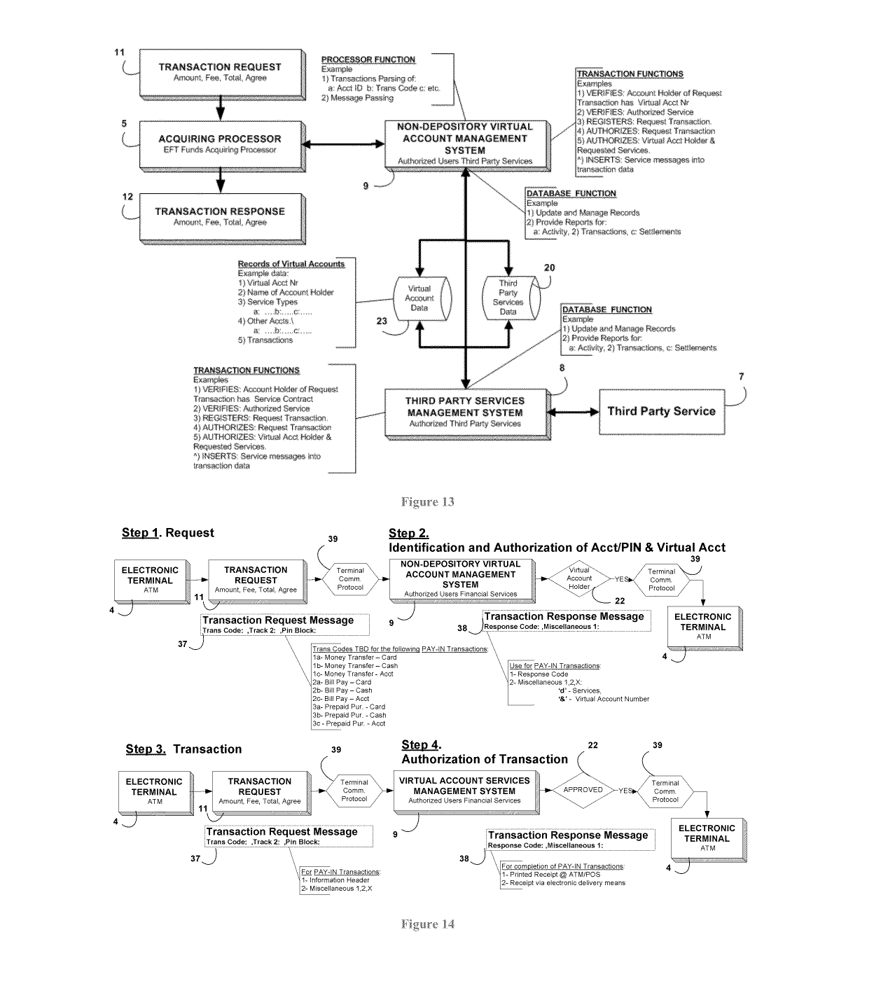

FIG. 7. Third Party Service Transaction Types example for iATM—PAY IN

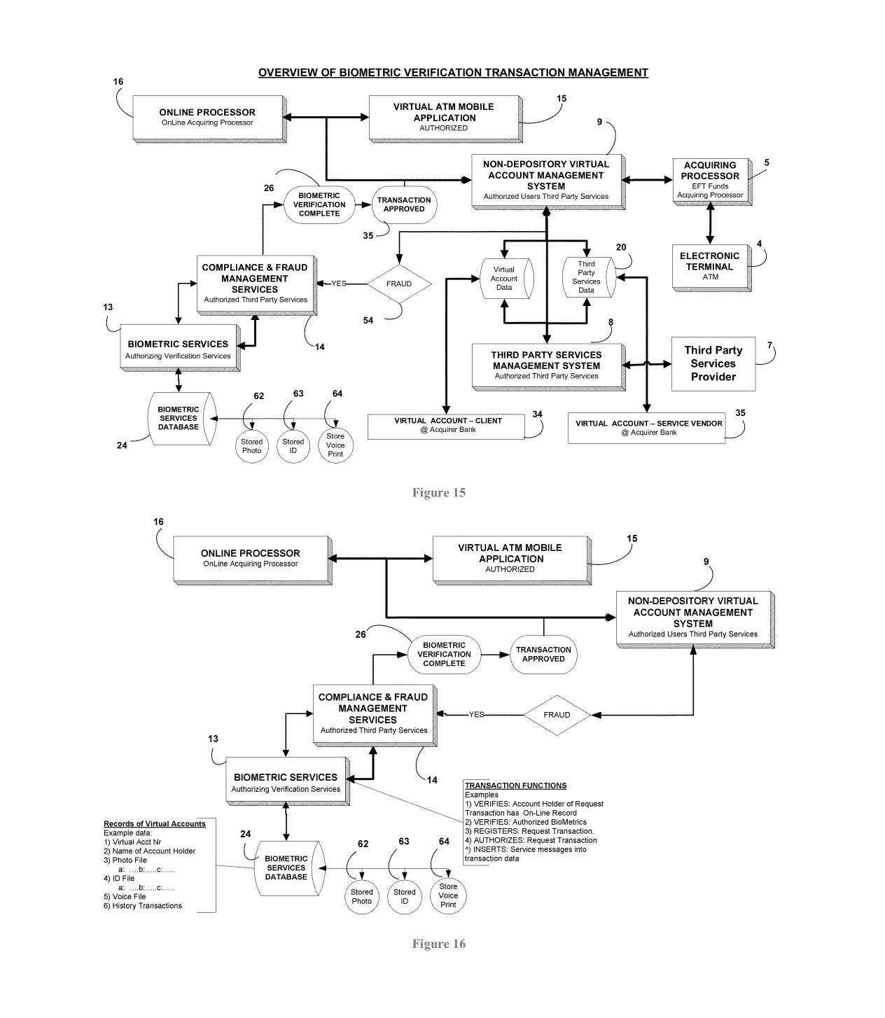

FIG. 8. Third Party Service Transaction Types example for iATM—PAY OUT

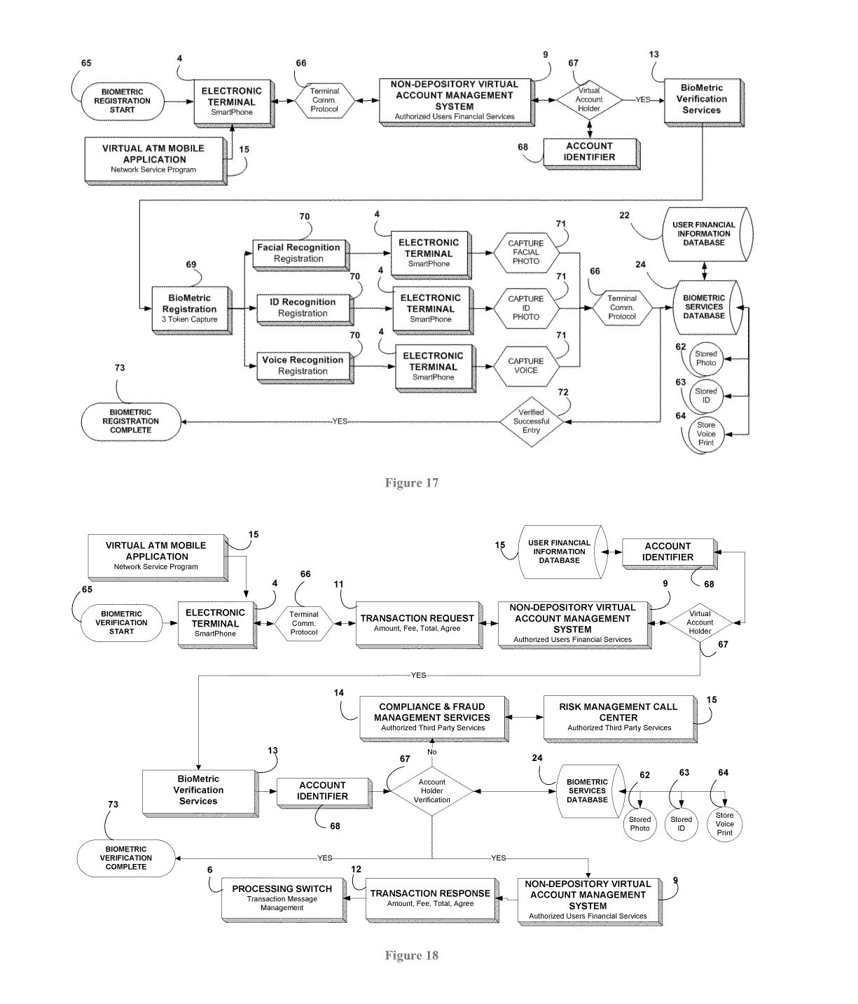

FIG. 9. Third Party Service Transaction Types example for iATM—PAY OUT at ATM/POS

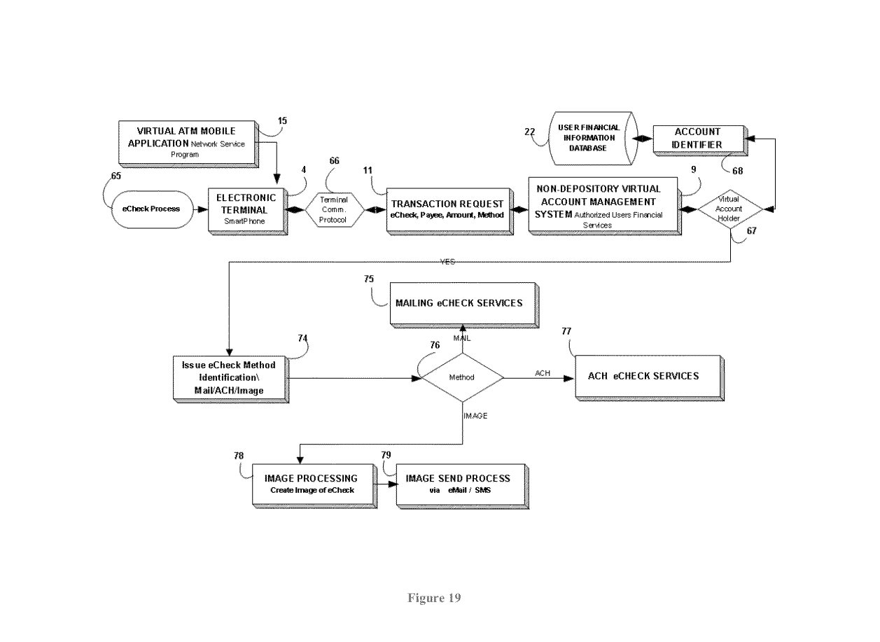

FIG. 10. Settlement Account Types

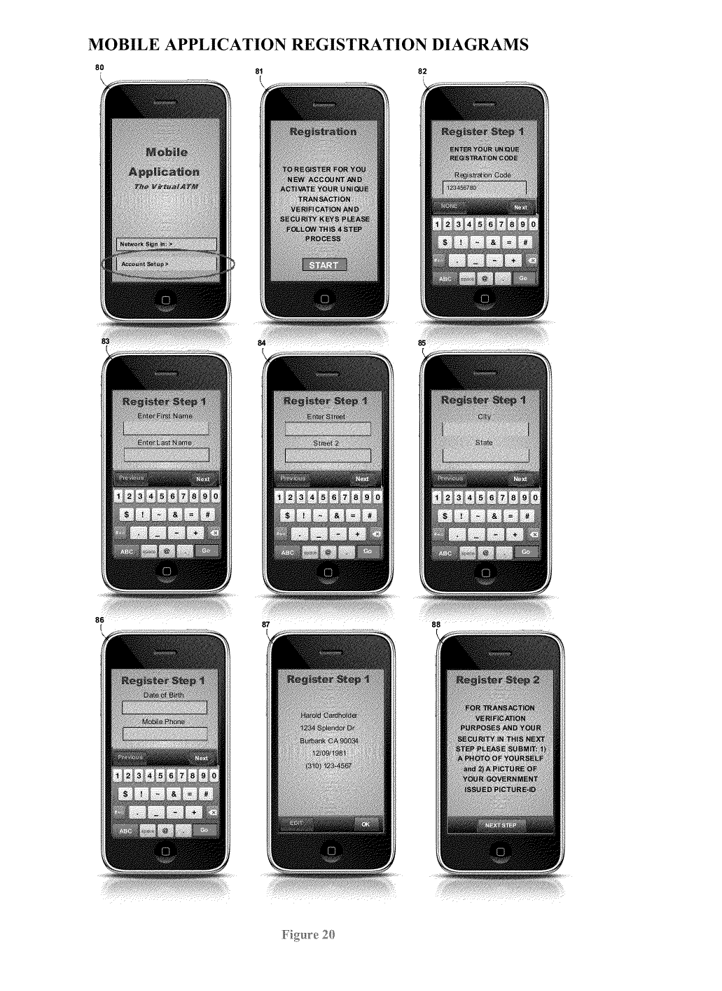

FIG. 11. Settlement Process Overview

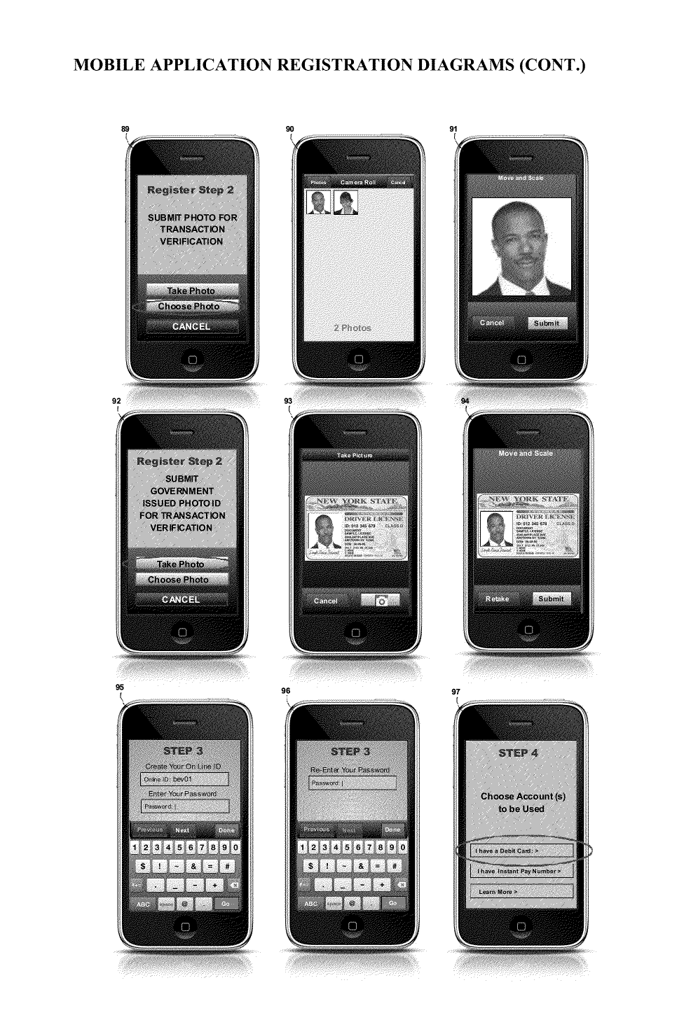

FIG. 12. Overview of Service Management System

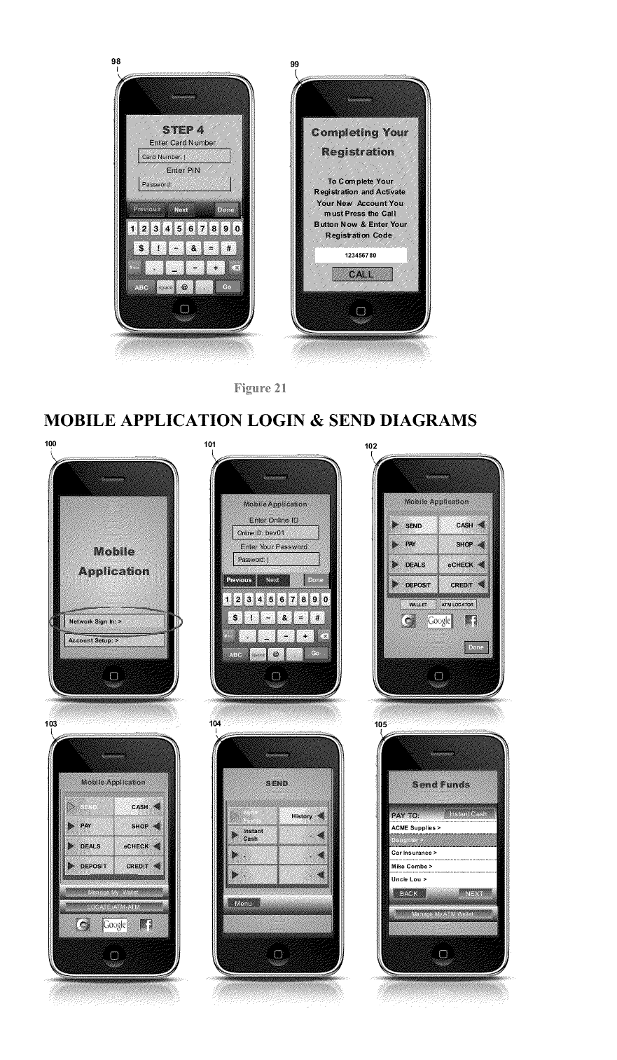

FIG. 13. Service Management System Functions

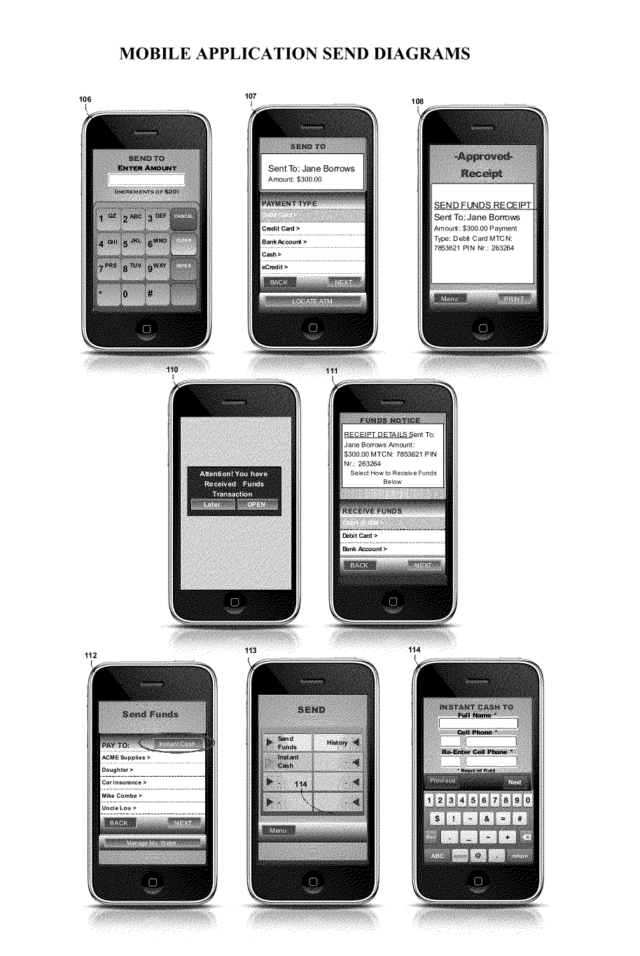

FIG. 14. Transaction Message Cycle

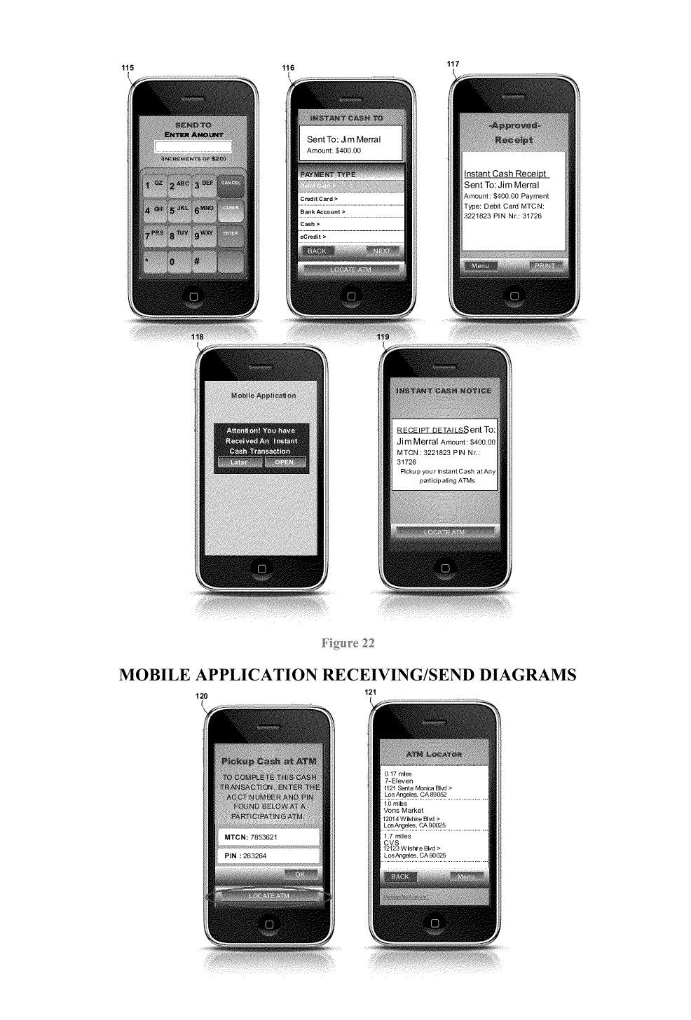

FIG. 15. Biometric Verification Transaction Management

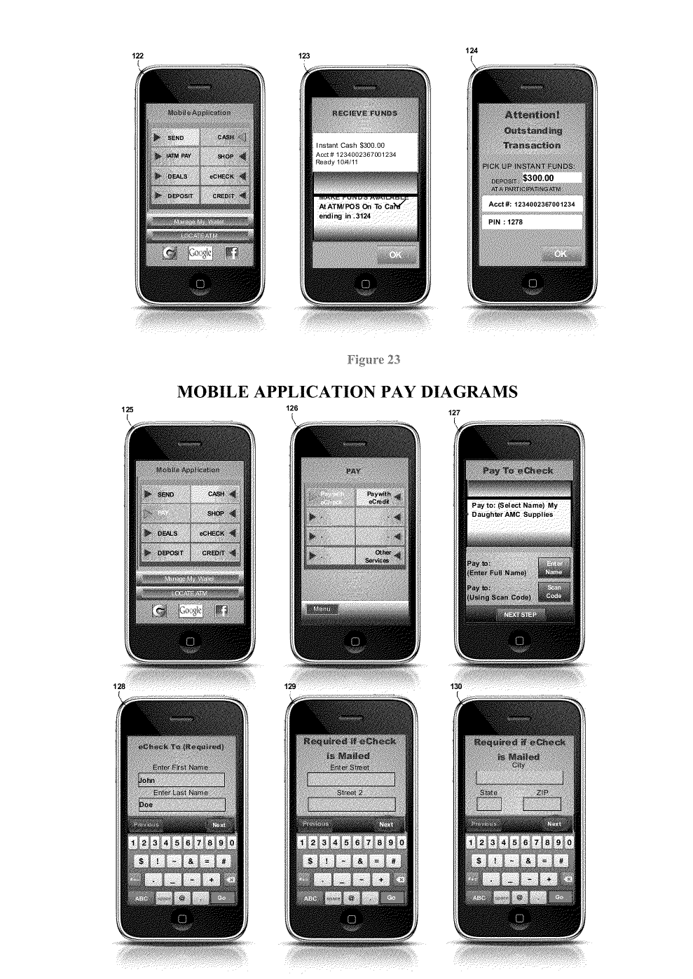

FIG. 16. Biometric Verification Transaction Management II

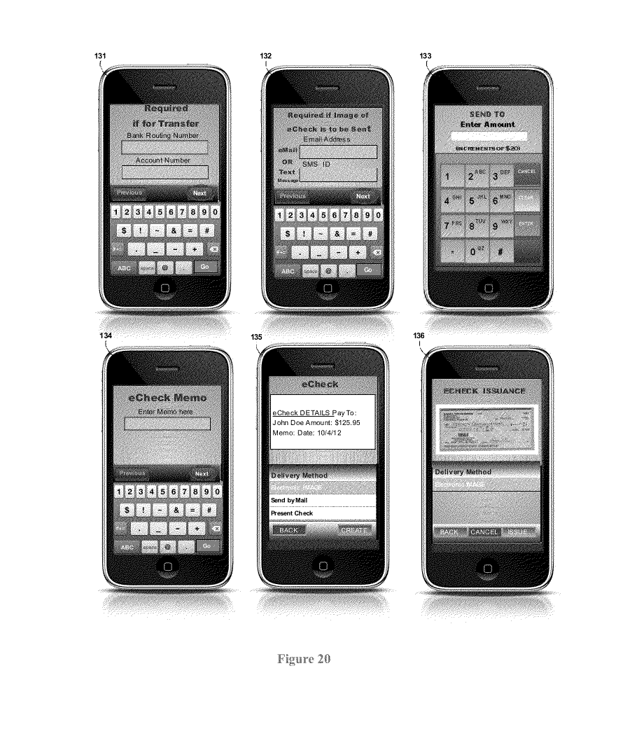

FIG. 17. Biometric ID Data Setup

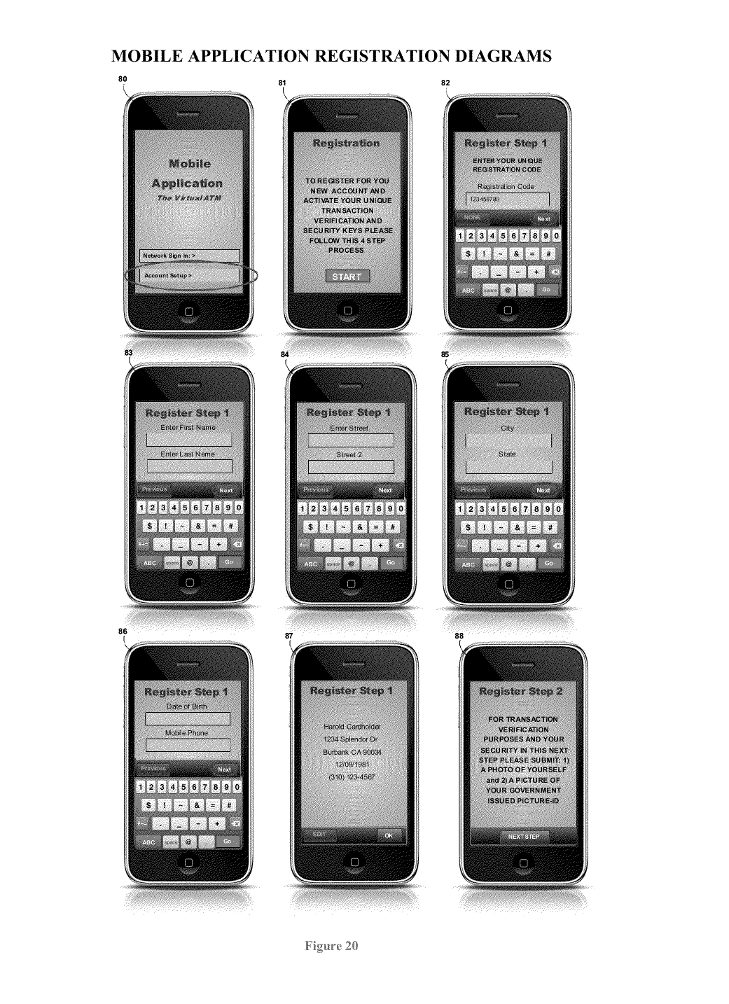

FIG. 18. Biometric Verification Cycle

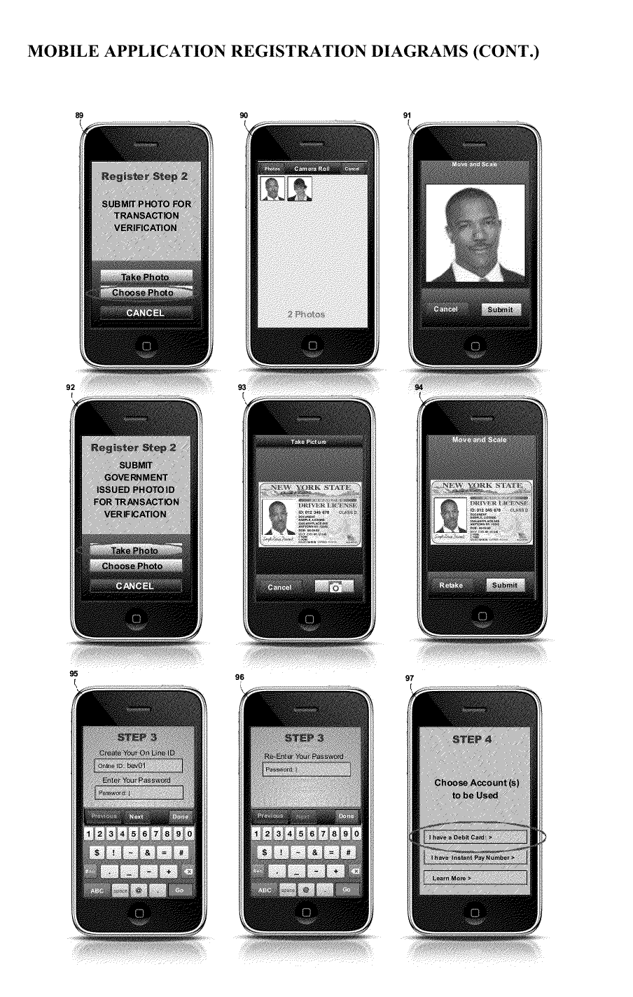

FIG. 19 illustrates the example of the eCheck issuance process

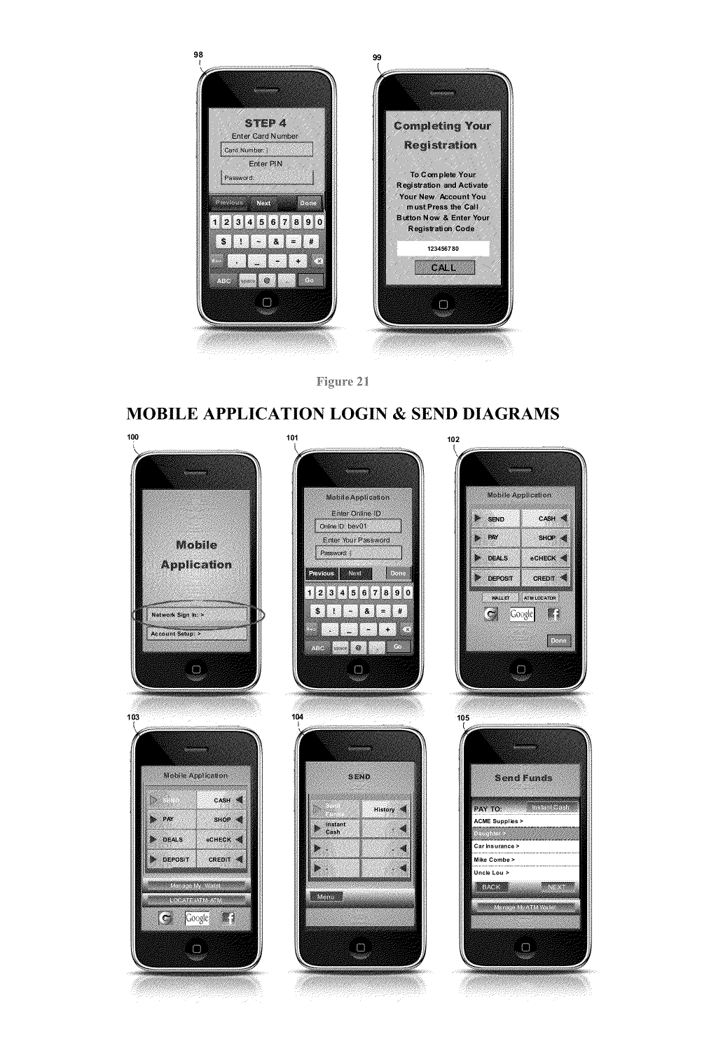

FIG. 20-24 Example—Integrated Automated Teller Application on Smart Phone Electronic Device

### DETAILED DESCRIPTION OF THE INVENTION FIRST EMBODIMENT

Referring now descriptively to the drawings, the attached figures illustrate the first embodiment of the system as a new and useful method for the execution of third party services transaction over financial networks through electronic terminal devices utilizing multifactor authentication techniques and a non-depository virtual account management system.

FIG. 1 illustrates the various operational domains utilized according to the present invention, the domain categories are:
1. A Financial Instrument Holder: A holder of a Credit Card, Prepaid Card, Debit Card, Bank Account, Check, Token, Line of Credit or Cash.
2. A Virtual Account Holder Client: An authorized User/Client who has registered to use the Third Party Services System.
3. A Virtual Account Holder Vendor: An authorized Third Party Services Provider who has registered to use the Third Party Services System.
4. An Electronic Terminal: A terminal interface device setup the purpose of facilitating a financial transaction used to communicate a request and complete a transaction, comprising but not limited to a POS terminal, ATM, Internet Computer, Smart Phone, and a Kiosk.
5. An Acquiring Processor: An Electronic Funds Transfer Acquiring Processor who handles the transaction requests and responses. Transaction acquiring processing includes various operational elements to complete a financial transaction request. There are three main components of the acquiring transaction: 1) Financial Networks that allow access to the participating financial institutions that issue financial instruments for transaction authorization or denial, 2) a processing system that acquires the transactions through an Electronic Terminal, and 3) an Acquirer Bank Settlement Account for transaction settlement funds.
6. Processing Switch: Financial transaction message executor and protocol manager.
7. Third Party Services Provider: The Provider of the third party service, comprising but not limited to a Money Transmitter, Lender, and Bill Payment Aggregator.
8. Third Party Services Management System: The part of the Service Information System that contains and handles the necessary data for the Third Party Service to issue their services within the Service Information System.
9. Non-Depository Virtual Account Services Management System: The part of the Service Information System that contains and handles the necessary data for the Financial Instrument Holder to access and utilize third party services within the Service Information System.
10. Financial Transaction Settlement: The settlement process for both Pay-Out and Pay-In transactions where funds are moved between users, merchants, processors and banks.
11. Transaction Request: A message protocol from the electronic terminal interface device to processor system.
12. Transaction Response: A message protocol from processor system to the electronic terminal interface device.
13. Biometric Services: Provides file transfer, file storage and authentication routines and logic for biometric on-line authentication services.
14. Compliance and Fraud Management Services: User compliance and fraud identification business rules and logic, accessed as a service or with the card management process and other compliances parameters and requirements governing the transaction.
15. Virtual ATM Mobile Application: An Integrated Automated Teller Machine (iATM) Mobile Device Application for authorized access to personal financial accounts and to 3^{rd} party financial services management system.
16. Online Processor (“Online Acquiring Processor”): An Online Management Service that handles the transaction requests and responses from on-line applications. Sends and receives messages regarding a transaction to and from acquiring processing includes various operational elements to complete a financial transaction request, and the Non-Depository Virtual Account Management System.

FIG. 2 illustrates the flow of a transaction that utilizes the Third Party Services Management System (8). A Financial Instrument Holder (1) utilizing an Virtual ATM Mobile Application (15) sends a request for service through the Online Processor (16) to the electronic terminal's Acquiring Processor (5) who manages the transaction message cycle. The identity of the Financial Instrument Holder (1) is checked by the Non-Depository Virtual Account Services Management System (9) for authorization for use of the third party service utilizing various data elements (20, 22, 23). If further transaction authorization is required the Third Party Services Management System (8) collects necessary data from data within the Vendor Services Information Database (21) as well as data from the Third Party Services Provider (7) providing the requested service. If the transaction is authorized all the above data is updated to reflect the transaction so that Financial Transaction Settlement (10) takes place and the Financial Instrument Holder (1) receives the requested service. The Online Processor (16) may validate and authorize the ID of the Financial Instrument Holder (1) via Biometric Services (13), where the biometric data stored in the Biometric Services Database (24) is compared (25) for the Verification process (26).

FIG. 3 illustrates the enrollment process for a client to obtain access to third party services. A Financial Instrument Holder (1) registers (30) for access to Third Party Services through the Virtual Account Services Management System (9), if approved (32), the Financial Instrument Holder (1) is issued a virtual account number and becomes a Virtual Account Holder Client (2). For those transaction services requiring authentication of an existing Virtual Account Holder Client (2), Biometric Services (13) are engaged to ‘lookup’ and verify the ID through biometric stored data (24). This process enables the Virtual Account Holder Client (2) to access third party services. The Virtual Account Holder Client (2) then registers with the Vendor Services Information Database (21), upon approval (32), the Third Party Service Provider (7) authorizes the Virtual Account Holder Client (2) via the Third Party Services Management System (8) which updates all necessary data elements (20, 21, 22, 23) for the Virtual Account Holder Client (2) is Registered with Third Party Services (31) to utilize that service over the network.

FIG. 4 illustrates the transaction process for a user to request and carryout a transaction involving a third party financial service. The Virtual Account Holder Client (not shown) utilizing an Electronic Terminal (4) and accessing the services through the Virtual ATM Mobile Application (15) and Online Processor (16) to the Non-Depository Virtual Account Management System (9) which qualifies the client as a registered user (33) enabling the Virtual Account Holder Client to select the transaction type (34) and thus carrying out the third party transaction (35), using all necessary data elements (20, 21, 22, 23) for the.

FIG. 5 illustrates the response for the request for third party service transaction, where the Virtual Account Holder Client (2) in this example utilizing the Virtual ATM Mobile Application (15) and Online Processor (16) has been identified as a registered user and able to execute a third party transaction (11). The Acquiring Processor (5) transmits and receives the necessary authorization (32) and information regarding the transaction (7, 8, 9) to complete the transaction (10), whereby the financial settlement (36) is processed utilizing the various data elements located in various databases (20, 21, 22, 23) regarding the transaction gathered by the Third Party Services Management System (8) and distributed by the Non-Depository Virtual Account Management System (9) thereby providing settlement instructions. Confirmation of transaction may be sent from Non-Depository Virtual Account Management System (9) to the Virtual ATM Mobile Application (15) via an Online Processor (16).

FIG. 6 illustrates an example of the various third party transaction types that may be utilized by the Virtual ATM Mobile Application (15) to the Third Party Services System (7). Each of the transaction types (37) has a specific provider of service (7). Each of the transaction types have a pay-in and pay-out (see arrows) protocol for settlement.

FIG. 7 illustrates an example of a few Third Party Services Transactions for the PAY-IN phase. The use Virtual Account Holder Client (not shown) enters, through the Virtual ATM Mobile Application (15), the transaction type/selection (38), the Payee Data (39), including to whom, amount, etc. and the account from which the payment is to be made from (40). If the transaction type requires (41) the Biometric Services (13) is engaged to Verify the ID of the user via stored Biometric Data (24) comparisons. The transaction request (11) is submitted through the Online Processor (16) for a Money Transfer Transaction (37) to be approved by the Third Party Service Provider (7)(20) offering the service. Once approved (35) the receipt of transaction (42) is sent to the Online Processor (16) for distribution.

FIG. 8 illustrates an example of a third party transaction for the PAY-OUT phase. To complete the example of a money transfer transaction, the Third Party Service Provider (7) upon approval (35) sends a message (43) with amount, from data and a Money Transmission Control Number (44) in an acceptable format (45) for the Online Processor (16) to notify the user Virtual Account Holder Client (not shown) through the Virtual ATM Mobile Application (15). The user selects the form of Pay-Out (46). In this example the user has selected “PAY-OUT Cash at ATM” (46). The Transaction Request (11) is forwarded through the Online Processor (16), if the PAY-OUT has not been made (47), the Funds Transfer Notification (48) is issued for use at an ATM/POS (50) for PAY-OUT in cash. See next diagram.

FIG. 9 illustrates an example of a third party transaction for the PAY-OUT where PAY-OUT in cash at an ATM/POS has been requested. The user Virtual Account Holder Client (2) enters the Account Number and Pin Number (51) and enter the Money Control Number (52) upon request at the Electronic Terminal (4). The Acquiring Processor (5) transmits the request to the Non-Depository Virtual Account Manager (9) for Transaction Approval (35). If a Compliance or Fraud issue (54) is detected or further authentication is required, the Biometric Services (13)(24) provides the positive verification of ID (26). If sufficient, the transaction is approved (35) and the Compliance and Fraud Management Services (14) approves the ID check for the Non-Depository Virtual Account Manager (9) which in turn approves the transaction resulting in cash being distributed at the ATM/POS Electronic Terminal (4)(55).

FIG. 10 illustrates the various accounts required (as an example) for third party services transaction settlement. The Financial Services Operating Account (55) is the active account where all third party transaction funds are settled to or from and is controlled by the Acquirer Processor (not shown). The Funding Account (56) funds the Operating Account (55) and is controlled by the Acquirer Processor. The Services Vendor Operating Account (60) can be referred to as a ‘Corresponding Bank Account’, is the active account where all third party transaction settlements due to the specific Third Party Service Provider (not shown) are settled and is controlled by Third Party Service Provider. The Third Party Services Reserve Account (59) has reserve funds available to cover any minimum balance requirements for the Financial Services Operating Account (55) and is controlled by the Non-Depository Virtual Account Services Management System (not shown). The Fee and Commissions Account (61) holds settlements pertaining to the transaction. The Merchant Settlement Accounts (62) and User Accounts (63) are the source accounts for transactions resulting in PAY-OUTs as well as the recipient accounts for transactions resulting in PAY-INs. Both the Virtual Account Holder Client (57) and the Virtual Account Holder Vendor (58) are non-depository accounts that are utilized by the Virtual Account Services Management System (not shown) to record, audit, report and enable settlement through the other accounts. One set of virtual accounts are for the Virtual Account Holder Client and the other set of accounts are for the Virtual Account Holder Vendor.

FIG. 11 illustrates the third party transaction settlement cycle, where the Virtual Account Holder Client (not shown) has entered a transaction (11) for a third party service. The settlement process begins when the transaction has been accepted by the Third Party Services Provider (7). The Transaction Response (12) provides the audit trail data required for issuing the instructions for settlement. The combination of the Non-Depository Virtual Account Management System (9) and Third Party Services Management System (8) gather the needed data elements in order to effect a PAY-IN or PAY-OUT transaction and settle funds through the appropriate settlement account (60,62) into the corresponding depository accounts (62,63) and records (57,58).

FIG. 12 illustrates the management of a third party transaction. Where the Electronic Terminal (4) is an ATM or a POS terminal all transactions are processed thru an Acquiring Processor (5). The selected elements of the transaction data is processed through the Non-Depository Account Management System (9). contains executable software code that accesses both Virtual Account Data (23) and Third Party Services Data (20) to determine whether or not the Financial Instrument Holder (1) is a Virtual Account Holder Client (2) and which third party services are available to the Client. The creation, maintenance and updating of Virtual Account Data and Third Party Services Data occurs from both the Non-Depository Virtual Account Management System (9) and the Third Party Management System (8). When transaction is complete, sufficient data to audit the transaction is placed within the Virtual Account Holder Client's data (23) within the Non-Depository Virtual Account Client (57) and the Virtual Account Holder Vendor's data (20) within the Non-Depository Virtual Account Vendor (58). The data (23, 20) within the Virtual Account Client (57) and the Virtual Account Service Vendor (58) triggers the settlement message process.

FIG. 13 illustrates an example of the data sets and functions that may be used for the execution, auditing and settlement of a third party transaction. See description texts within the figure for explanations of data field types. The Non-Depository Account Management System (9) in some cases may have to handle various message processes on top of the Acquiring Processor's (5) function; Including but not limited to message parsing, verifying and authorizing a transaction, inserting service messages into the transaction stream and well as updating various data (23,20).

FIG. 14 illustrates an example of the data sets and functions (37, 38) that may be used to support the Terminal Communications Protocol (39) stage of the transaction by the Transaction Request (11) step.

FIG. 15 illustrates an example of the Biometric Verification Transaction Management process. The Virtual ATM Mobile Applications (15), thru the Online Processor (16) requests a transaction thru the Non-Depository Virtual Account Management System (9). If required due to Compliance issues and/or Fraud Identification (54), the Compliance and Fraud Management Services (14) request the Biometric Verification Services (13) to verify the ID of the User, by comparing the stored biometric data (24)(62)(63)(64). If Biometric Verification is completed (26), the ID is verified than the Transaction is Approved (35) and the Non-Depository Virtual Account Management System (9) initiates the completion of the transaction via (8)(34)(35)(7).

FIG. 16 illustrates an example of the data sets and functions (13)(24) that may be used to support the Biometric Verification Process (26) stage of the transaction as required by Compliance and Fraud issues.

FIG. 17 illustrates an example of the registration process for entering Biometric Data (62)(63)(64) into the Biometric Services Database (24) and User Financial Information Database (22).

FIG. 18 illustrates an example of the Biometric Process when requested by the Non-Depository Virtual Account Management System (9) via a transaction Request (11).

FIG. 19 illustrates the check image generation (eCheck) and issuance process by a request from an individual using the iATM Interface Application for an Electronic Terminal (15) to make a transaction Request (11) of a Payment to a Payee for a specific amount. Once the transaction is approved (17) (46) (48), the individual chooses the method of delivery (74). If the method of delivery is mailing, the check is printed and mailed to the Payee (75). If the check is to be delivered via bank transfer (ACH), the management system generates an ACH (77). On the other hand if the individual wishes to send an electronic image of the request transaction check, an electronic image is constructed utilizing the individual's financial information (22) bank routing and non-depository virtual account data (9) to produce (78) the check image in real time. The electronic check image is than delivered, by the method designated by the individual, to the payee (79)

FIG. 20 illustrates an example of an iATM Human Interface Application for an Electronic Terminal (15). Once the iATM application has been downloaded to a Smart Phone (as an example of a device) the user (if not previously Registered) must Register. Registration begins with the iATM Account Setup registration process (80), registration instructions (81) and entering a unique identifier or promo code to track the source of the referral and initiating Registration Step 1 (82). The Registration Process is illustrated (83) (84) (85) (86) (87) (88) where the following required registration personal information is entered. The series of actions illustrated in this Figure activates the process described in FIG. 3

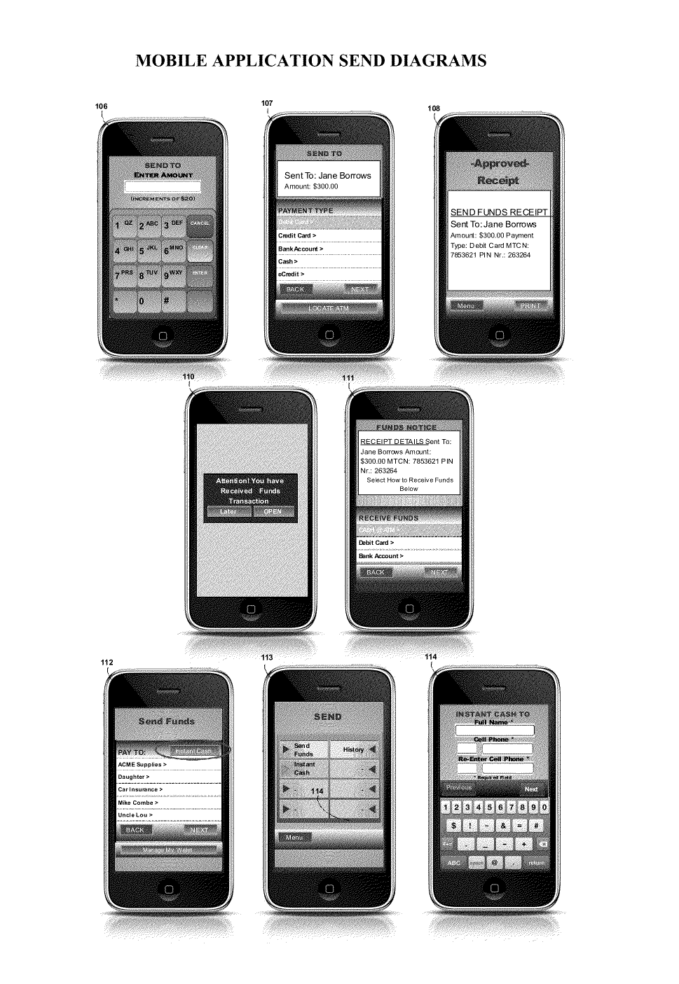

FIG. 21 illustrates an example of an iATM Human Interface Application for an Electronic Terminal (15). The ‘Know Your Customer’ requirement for Registration is illustrated (89) (90) (91) (92) (93) (94) where the following required registration personal information is entered. (95) (96) illustrate the Network Login Setup. (97) (98) Illustrates the option of attaching a Funding Account to the Registrant's IATM Account. (99) Illustrates the confirmation of Registration routine. The series of actions illustrated in this Figure activates the process described in FIG. 3

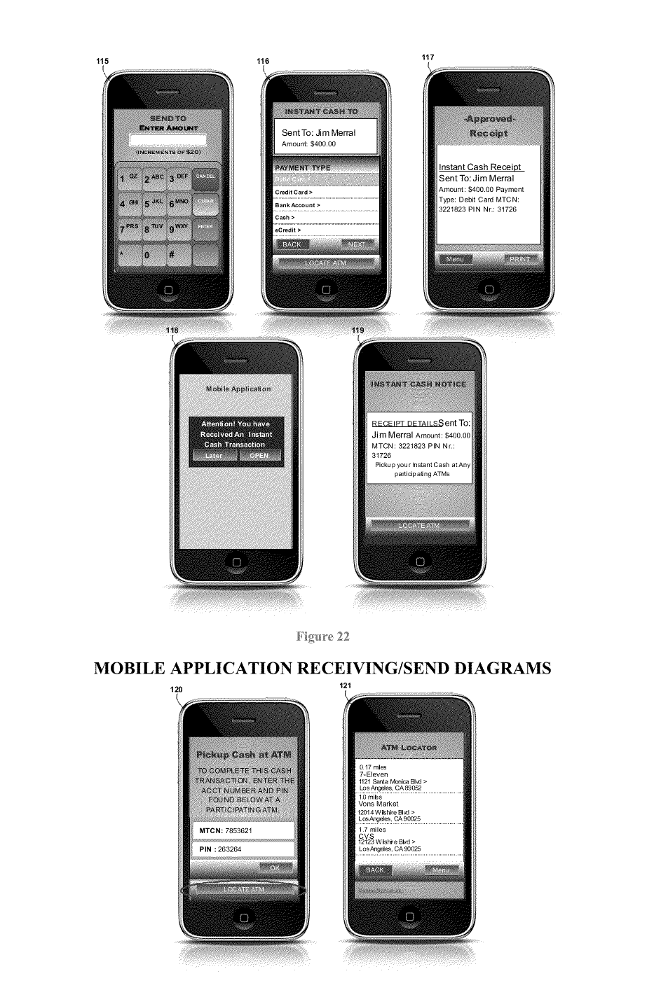

FIG. 22 illustrates an example of an iATM Human Interface Application for an Electronic Terminal (15). (100) (102) Illustrates the Application to Login to the iATM

Network process; gaining access to the Main Menu (102). In this example the Registered User selects the (103) the Send Option, Send Funds Option (104); than select to whom the Funds are to be Sent (105) along with the amount (106); Illustrates the transaction review screen (107); and a receipt is generated (108).

(110) Illustrates the message to the Recipient of the Funds received and the Recipient may by logging into their iATM Account to receive the funds in a number of ways (111). The following Send example utilizes the Instant Cash Transaction Option (112) (113) (114) (115) (116) (117); along with its corresponding Receipt Notice (118) (119). The series of actions illustrated in this Figure activates the process described in FIGS. 4 and 5

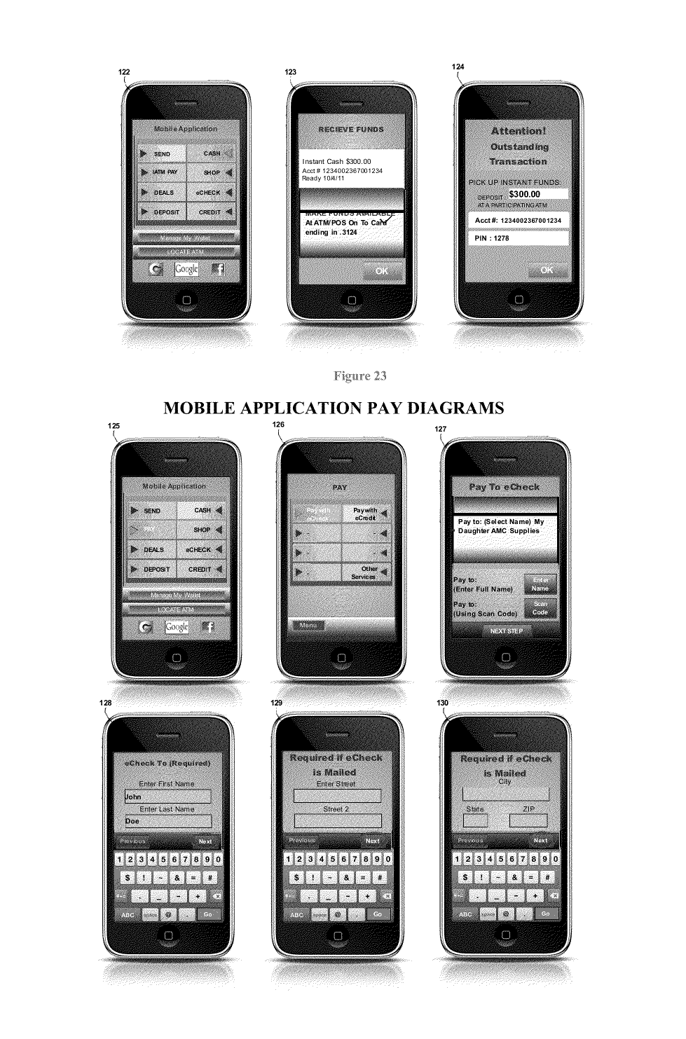

FIG. 23 illustrates an example of an iATM Human Interface Application for an Electronic Terminal (15). This illustrates the Receiving Party's use of the Application (120,121), where the recipient has received the necessary information to get their cash from an ATM (128). (122, 123,124) Illustrates another example of sending Instant Cash utilizing the Application. The series of actions illustrated in this Figure activates the process described in FIGS. 4 and 5

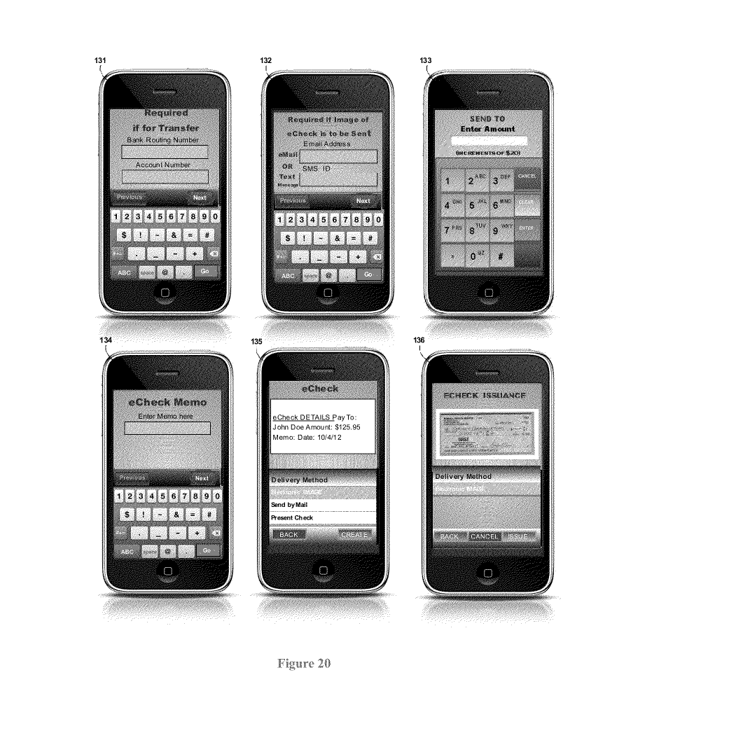

FIG. 24 illustrates an example of an iATM Human Interface Application for an Electronic Terminal (15). Illustrates the Pay Out Process utilizing the Application, where the Pay Out is in the form of an eCheck (125) (126). (127) Illustrates to whom the eCheck is to be issued to. An option for the payee to be identified and collect the required data for the PAY-OUT is available via a readable code obtained from a file, photo or scan code. (128) (129) Illustrates the collection of the required data for mailing the eCheck; (131) Illustrates the collection of the required data for transferring the eCheck via ACH. (132) Illustrates the collection of the required data for sending a eCheck Image via eMail or SMS Texting (or other forms of electronic image transfer means not shown). This step enables the user to Issue an eCheck and send it to a recipient who than can deposit it as an electronic image or print it out for deposit. (133) Illustrates the amount to be printed on the eCheck. (134) Illustrates the data collection of a Memo Field. (135) (136) Illustrates the review of the eCheck request and eCheck electronic Image when requested. The series of actions illustrated in this Figure activates the process described in FIGS. 4, 5, 11, 14, 15, 16, 17, 18, and 19

### CONCLUSION, RAMIFICATIONS, and SCOPE

In conclusion the reader will see that first embodiment of the system provides a more reliable and more useful method of enabling access to third party financial services through electronic terminals via financial networks than currently exists in the prior art. While the above description contains many specificities, these should not be construed as limitations on the scope, but rather as an exemplification of one embodiment thereof. Many other variations are possible.

Furthermore any ramifications that may arise from one or more elements being eliminated or duplicated, connected or associated with each other in a different manner, given a different mode or function of operation and/or made integrally or separately that may arise from future technological innovations or modifications in the financial networks' or electronic terminals' communications specification protocols does not materially invalidate the claims made herein.

Accordingly, the scope should be determined not by the embodiment illustrated, but the appended claims and their legal equivalents. It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

### GLOSSARY OF TERMS

1. Acquiring Processor: The host data processing entity that acquires the transaction from the electronic terminal.
2. Electronic Terminal: Any electronic terminal that can effect a payment.
3. Financial Instrument Holder: An individual that possesses the means of effecting a payment at an electronic terminal in a Pay-In transaction or conversely receives a payment at an electronic terminal in a Pay-Out event.
4. Financial Networks: Any network that enables electronic funds transfers via electronic terminals.
5. Financial Network Settlement: The settlement of funds that are paid and received by the relevant parties to the transaction.
6. Pay-In Transaction: A payment event in which a financial instrument holder effects a payment to a third party through an electronic terminal.
7. Pay-Out Transaction: A payment event in which a financial instrument holder receives a payment from a third party through an electronic terminal.
8. Processing Switch: The network access for the Electronic Terminal to the Acquiring Processor and the Virtual Account Management System.
9. Merchant Vendor: Any merchant that owns and/or operates electronic terminals such as ATM and POS systems.
10. Non-Depository Virtual Account Management System: A system of managing non depository accounts that enable financial instrument holders to access third party vendor systems during the course of a single session on an electronic terminal and to pass the data between the financial instrument holder and the third party service provider through the electronic terminal's transaction acquiring processor.
11. Operating Accounts (Depository): Accounts that can accept deposits held at depository institutions including bank accounts and stored value accounts.
12. Settlement Accounts: Temporary custodial accounts held at depository institutions for the purpose of settling funds between the relevant parties in a transaction.
13. Third Party Services Management System: A system that is managed by the Third party Service Provider that stores Virtual Account Holder Client data and authorizes or denies the Transaction Request from the Financial Instrument Holder.
14. Third Party Service Provider: Any third party providing a service that is not a depository institution.
15. Transaction Request: The transaction request through the Processing Switch for an authorization or declined transaction response.
16. Transaction Response: The transaction response through the Processing Switch to authorize or decline a transaction request.
17. Virtual Account Holder Client: The virtual account holder member that has registered with the Virtual Account Management System.
18. Virtual Account Holder Vendor: The third party services provider that has registered with the Virtual Account Management System.
19. Virtual Service Accounts (Non-Depository): Accounts that do not accept deposits and are used to provide access to third party services through financial networks.

I claim:

1. A new method and system comprised of a plurality of instructions that, when executed by one or more processors, causes the processors to perform acts including: the issuance of a third party service's financial transaction over financial networks, comprising:
a. Providing access for initiating a financial transaction system for the execution of the third party service's financial transaction through a financial network as requested by an individual, and
b. Providing access for initiating the financial transaction system for the settlement of the third party service's financial transaction as requested by an individual over financial networks utilizing acquiring processors, merchant vendors, financial instrument issuing banks and third party service providers.
c. Providing access to a new use data set for the identification and authorization of an individual's request of the third party service's financial transaction utilized by the financial networks' transaction system.
d. Providing access to a new use data set for the identification and authorization of the requested third party service's financial transaction utilized by the third party service providers.
e. Providing access to a new use data set for the identification and authorization of the requested third party service's financial transaction utilized by an acquiring processor.
f. Providing access to a new use data set for the identification and authorization of the requested third party service's financial transaction utilized by a merchant vendor servicing third party service's financial transactions.
g. Providing access to a new use data set for the identification and authorization of the requested third party service's financial transaction utilized by an individual's depository account for settlement of the third party service's financial transaction.
h. Providing access to a new use data set for the identification and authorization of the requested third party service's financial transaction utilized by the individual's financial instrument issuer.
i. Providing access to a new use data set that is compatible with the financial network's messaging protocols.
Whereby the individual's requests for the transaction with the third party service provider other than a direct bank or merchant vendor servicing third party service's financial transactions transaction can than be carried out on existing financial networks.

2. A method for an individual to initiate the transaction of claim 1 comprising a non-depository account management system for the integration and generation of a data set message used for the identification and authorization process of a requested third party service's financial transaction by an individual.

3. A method for an individual to initiate the transaction of claim 1 the settlement of the third party service's financial transaction over financial networks; by providing for the management of the execution and settlement of the third party service's financial transaction over financial networks utilizing existing financial networks, merchants vendors, acquiring processors, financial instrument (card) management systems, financial instrument issuers and financial network protocols

4. A method for an individual to initiate the settling the transaction of claim 3 by:
a. Providing a new method and the data set to be used by a non-depository account management system for transaction identification, authorization and settlement of the third party service's financial transaction.
b. Providing a new method and the data set to be used for the third party service's financial transaction to be authorized and settled through financial networks utilizing the non-depository account management system.
Whereby the individual's request for the third party service's financial transaction is settled on existing financial networks.

5. A method of claim 4 for an individual to initiate the settlement of the transaction comprised of a data set for the identification and authorization of said requested third party service's financial transaction utilized by the financial instrument issuer.

6. A method for settling the transaction of claim 4 comprising of new authorization and settlement process of the third party service's financial transaction between the third party service (the third party service's system and related settlement accounts, depository and/or non-depository accounts); between the initiator of the transaction, the acquiring processor of the transaction and the issuer of a financial instrument and the depository account.

7. A method for the individual to settle the transaction of claim 4 comprising of a process for tracking the Pay-In and Pay-Out cycle of the third party service's financial transaction.

8. A method for the individual for settle the transaction of claim 4 comprising:
a. Providing the individual access to various accounts as required for transaction settlement including a Financial Services Operating Account, a Funding Account, an Operating Account, Third Party Service Vendor's Operating or Corresponding Account, a Third Party Service Vendor Reserve Account, Merchant Operating Account, and
b. Providing the individual access to various accounts as required for the auditing, recording, reporting and settlement data of the individual transaction settlement including a non-depository Financial Instrument Holder Account
Whereby an individual's request for the third party service transaction is audited, recorded and reported on when the transaction is completed.

9. An new use for the handling of an individual's initiation of a request, authorization, execution and settlement of a third party transaction over financial networks by an individual by providing a new use for electronic terminal devices to offer and facilitate a third party service transaction and a means for real-time sequential processing of a third party transaction over financial networks by an individual, utilizing multifactor authentication techniques and image capture technology to mitigate fraud and insure regulatory recordkeeping and anti-money laundering compliance;

10. A new use of claim 9 comprising:
a. Providing the individual access to a message protocol integrated into the electronic terminal interface device for transmission to and from the acquiring processor and
b. Providing the individual access to the electronic terminal device to enable the third party service to offer the financial transaction to an individual and
c. Providing the individual access to a customized interface for the electronic terminal device to enable the third party service to offer the financial transaction to an individual and
d. Providing the individual access to the customized interface for the electronic terminal device to enable the individual to access the third party service's financial transaction and
e. Providing the individual access to the customized interface for the electronic terminal device to enable the acquiring processor to offer the individual access said third party service's financial transaction
f. Providing the individual access to said customized interface for the electronic terminal device to settle said third party service's financial transaction for the individual's request of said third party service's financial transaction and
g. Providing the individual access to said electronic terminal device's screen interface for the entry and execution of said third party service's financial transaction.
Whereby, the individual's requested third party service's financial transaction is executed in real-time.

11. A method for accessing said transaction of claim 9 the system for the management of the third party service's financial transaction over financial networks; by providing the individual access to the management system for the execution and settlement of said third party service's financial transaction over financial networks utilizing existing financial networks, merchants vendors servicing third party service's financial transactions, acquiring processors, financial instrument management systems, financial instrument issuers and financial network protocols.

12. A new use system of claim 9, utilizing non-depository accounts to manage the integration of the individual's request for the third party transaction, including the identification of the third party service provider offering the service, the identification of the terms of the third party transaction, the authorization of the individual's acceptance for the third party service by the third party service, the authorization of the individual's request for the third party service, the authorization of the execution of the third party service's financial transaction to the individual, the authorization of the execution of the third party service's financial transaction for the acquiring processor, the financial instrument issuer, merchant vendor and electronic terminal device.

13. A new use system of claim 9 comprising:
a. Utilizing the checks and balances within non-depository and depository accounts held by all parties to the transaction for the settlement of the transaction in real-time, and
b. Utilizing said non-depository and depository accounts held by all parties to the transaction for settlement of the transaction as required by the Third Party Service Provider, the Issuer of the Financial Instrument, the acquiring processor and financial networks for—Pay-In, Pay-Out fee settlement, and
c. Utilizing said non-depository and depository accounts held by all parties to the transaction for said settlement of the third party service's financial transaction as required by said Third Party Service Provider, said Issuer of said Financial Instrument, the acquiring processor and financial networks for said Pay-In, Pay-Out fee settlement,
Whereby the use of the non-depository account individual's accessed through an electronic terminal(s) and related Management System enable the individual to request and execute the Third Party Service Transaction on an existing financial network.

14. A method of claim 9 for authenticating and validating the individual user of said electronic terminal device, comprising:
a. Utilizing the electronic terminal device to capture and upload facial image for biometric identification to the system for authentication and validation of the electronic terminal device individual user, and
b. Utilizing the electronic terminal device to capture and upload a valid picture ID for individual user identification verification and for record keeping compliance.

15. A new method and system comprised of a plurality of instructions that, when executed by one or more processors, causes the one or more processors to perform acts including: the issuance of a electronic check image, comprising:
a. Providing access for an individual to initiate a financial transaction on a financial transaction system for the issuance of an electronic check image with required data for the issuance and final settlement of the check as requested by an individual on an electronic terminal device, and
b. Providing access for the individual to the system's utilization of the checks and balances within—non-depository and depository accounts held by all parties to the transaction for the settlement of the transaction in real-time.
c. Providing access for the individual to initiate the financial transaction system to delivery to a recipient of an electronic check image over existing communications networks.
d. Providing tan electronic check image to the recipient for printing the check.
e. Providing an electronic check image to the recipient for deposit into recipient's bank account.
Whereby the individual's requests for said check image can than be carried out on existing financial networks and communication networks.

16. A new use of claim 14 comprising:
a. Generating an electronic check image as requested by an individual in real-time, and
b. Delivering an electronic check image as requested by an individual in real-time in a method selected by the individual.
c. Utilizing multifactor authentication to validate the transaction.
d. Generating and storing the electronic check image and valid ID image on the system for compliance.
e. Uploading at the request of the individual, the electronic check image for record keeping on the individual's electronic terminal.
